(19) United States
(12) Patent Application Publication
(10) Pub. No.: US 2012/0202665 A1
(43) Pub. Date: Aug. 9, 2012

(54) PARTITIONED CONTAINER AND METHOD OF MAKING SAME

(75) Inventors: Scott D. Younger, Seattle, WA (US); John V. Heise, Federal Way, WA (US); Allen R. Tresch, Orting, WA (US)

(73) Assignee: ALLIANCE PACKAGING, LLC, Renton, WA (US)

(21) Appl. No.: 13/450,195

(22) Filed: Apr. 18, 2012

Related U.S. Application Data
(62) Division of application No. 13/333,748, filed on Dec. 21, 2011.
Application No. 13/333,748 is a continuation of application No. 12/335,345, filed on Dec. 15, 2008, now Pat. No. 8,152,051.

(51) Int. Cl. B31B 3/00

(52) U.S. Cl. 493/162

(57) ABSTRACT

A partitioned container includes an outer case member erectable from a substantially flat condition to an expanded condition, and at least one partition formed from a unitary blank separate from the outer case member and configured to couple to at least one interior surface of the outer case member in the flat condition, the unitary blank including at least one divider panel and at least one cross member configured to automatically divide an interior of the outer case member into a plurality of cells when the outer case member is erected to the expanded condition. A partition blank for forming the partition member and a method of manufacturing a partitioned container are also provided.

### CROSS-REFERENCE TO RELATED APPLICATIONS

This application is a divisional of U.S. patent application Ser. No. 13/333,748, filed Dec. 21, 2011, now pending, which is a continuation of U.S. patent application Ser. No. 12/335,345, filed Dec. 15, 2008, now issued as U.S. Pat. No. 8,152,051, where these applications are incorporated herein by reference in their entireties.

### BACKGROUND

1. Technical Field

This disclosure is generally related to containers, and more particularly, to partitioned containers having a plurality of cells for receiving, storing and/or transporting various articles, such as, for example, bottles.

2. Description of the Related Art

Containers, such as corrugated containers, having partition members to divide the containers into a number of cells or regions for receiving various articles, such as, for example, wine bottles and other packaged goods, have been in use for many years. For example, a partitioned container formed using a number of interlocking partition members and others like it, that require multiple folding and/or assembly steps prior to insertion into the container, are well known. Furthermore, these partitions typically extend completely from each side of the container to the other and fill an entire height of the container, thereby utilizing a relatively large amount of material to receive and separate articles.

Applicant believes that partitioned containers adapted to effectively receive and separate articles in a form factor or package having reduced material demands and enhanced assembly characteristics are desired.

### BRIEF SUMMARY

A partitioned container particularly adapted to receive and separate articles in a form factor or package characterized by reduced material demands and enhanced assembly characteristics may be summarized as an erectable partitioned container having at least one unitary partition member attached to and enclosed within a conventional outer case blank in a flat condition such that, when the outer case blank is erected in a conventional manner, the at least one partition member automatically erects or expands to form a plurality of cells for receiving and separating various articles. This is particularly advantageous in reducing the time required to assemble or form partitioned containers at or near a point of use. Furthermore, because the partition member is attachable to the outer case blank in a flat condition, further efficiencies are gained by reducing the need to pre-assemble the partition member prior to attachment to the outer case blank. Although the size, shape and number of the formed cells may vary, various embodiments of the present invention are particularly adapted to form six or twelve substantially equal cells for receiving and separating articles of like kind, such as, for example, wine bottles. To reduce the amount of material required to partition such articles, the at least one partition member has, in some embodiments, a height less than the height of the partitioned container and a partitioning surface area less than a primary side surface of the partitioned container. In this manner, a particularly environmentally friendly partitioned container is formed.

According to one embodiment, a partitioned container comprises an outer case member erectable from a substantially flat condition to an expanded condition, and a first partition formed from a unitary blank separate from the outer case member and configured to couple to at least one interior surface of the outer case member in the flat condition, the unitary blank including at least one divider panel and a plurality of cross members configured to automatically divide an interior of the outer case member into a plurality of cells when the outer case member is erected to the expanded condition.

According to another embodiment, an erectable partition blank for partitioning a container comprises a divider panel having at least a divider panel contact region for coupling the divider panel to a first interior surface of an outer case blank, the outer case blank being adapted to erect to form an outer case of the container, and a plurality of cross members integral to the divider panel, each cross member having a cross member contact region for coupling one or more of the plurality of cross members to at least a second interior surface of the outer case blank, and wherein the partition blank is configured to erect with the outer case blank from a substantially flat condition to an expanded condition in which the cross members of the partition blank extend substantially perpendicular to the divider panel to divide an interior of the outer case into a plurality of cells.

According to another embodiment, a method for forming an erectable partitioned container comprises forming a unitary partition blank to include a plurality of cross members and one or more divider panels, each cross member hinged to the one or more divider panels for rotation to an erected configuration, coupling a contact region of at least one of the plurality of cross members of the unitary partition blank to an interior surface of an outer case blank, and folding the outer case blank about a first fold line and a second fold line to couple an end of the outer case blank to a flap of the outer case blank to thereby form an erectable container structure in a flat configuration, the erectable container structure substantially enclosing the unitary partition blank and being configured to automatically rotate the plurality of cross members of the unitary partition blank to the erected configuration when the erectable container structure is erected to form a partitioned container.

### BRIEF DESCRIPTION OF THE SEVERAL VIEWS OF THE DRAWINGS

FIG. 1 is a partially cut-away perspective view of a partitioned container according to one embodiment.

FIG. 2 is a plan view of a partition blank for forming a partition member according to one embodiment.

FIG. 3A is a plan view of an outer case blank for forming an outer case member with the partition blank of FIG. 2 attached thereto.

FIG. 3B is a plan view of the outer case blank and partition blank of FIG. 3A folded about line a.

FIG. 3C is a plan view of the outer case blank and partition blank of FIG. 3A folded about line a and line b.

FIG. 4 is a partially cut-away perspective view of the outer case blank and partition blank of FIG. 3C in an expanded condition.

FIG. 5 is a top schematic view of the outer case blank and partition blank of FIG. 3C in an expanded condition.

FIG. 6 is a plan view of a partition blank for forming a partition member according to one embodiment.

FIG. 7 is a plan view of the partition blank of FIG. 6 in a folded condition.

FIG. 8A is a plan view of an outer case blank for forming an outer case member with the folded partition blank of FIG. 7 attached thereto.

FIG. 8B is a plan view of the outer case blank and partition blank of FIG. 8A folded about line a.

FIG. 8C is a plan view of the outer case blank and partition blank of FIG. 8A folded about line a and line b.

FIG. 9 is a partially cut-away perspective view of the outer case blank and partition blank of FIG. 8C in an expanded condition.

FIG. 10 is a top schematic view of the outer case blank and partition blank of FIG. 8C in an expanded condition.

FIG. 11 is a plan view of a partition blank for forming a partition member according to one embodiment.

FIG. 12A is a plan view of an outer case blank for forming an outer case member with two partition blanks of FIG. 11 attached thereto.

FIG. 12B is a plan view of the outer case blank and partition blanks of FIG. 12A folded about line a.

FIG. 12C is a plan view of the outer case blank and partition blanks of FIG. 12A folded about line a and line b.

FIG. 13 is a partially cut-away perspective view of the outer case blank and the partition blanks of FIG. 12C in an expanded condition.

FIG. 14 is a top schematic view of the outer case blank and partition blanks of FIG. 12C in an expanded condition.

FIG. 15 is a plan view of a partition blank for forming a partition member according to one embodiment.

FIG. 16A is a plan view of an outer case blank for forming an outer case member with the partition blank of FIG. 11 and the partition blank of 15 attached thereto.

FIG. 16B is a plan view of the outer case blank and partition blanks of FIG. 16A folded about line a.

FIG. 16C is a plan view of the outer case blank and partition blanks of FIG. 16A folded about line a and line b.

FIG. 17 is a partially cut-away perspective view of the outer case blank and the partition blanks of FIG. 16C in an expanded condition.

FIG. 18 is a top schematic view of the outer case blank and partition blanks of FIG. 16C in an expanded condition.

FIG. 19 is a plan view of a partition blank for forming a partition member according to one embodiment.

FIG. 20 is a plan view of the partition blank of FIG. 19 in a folded condition.

FIG. 21A is a plan view of an outer case blank for forming an outer case member with the folded partition blank of FIG. 20 attached thereto.

FIG. 21B is a plan view of the outer case blank and partition blank of FIG. 21A folded about line a.

FIG. 21C is a plan view of the outer case blank and partition blank of FIG. 21A folded about line a and line b.

FIG. 22 is a partially cut-away perspective view of the outer case blank and partition blank of FIG. 21C in an expanded condition.

FIG. 23 is a top schematic view of the outer case blank and partition blank of FIG. 21C in an expanded condition.

FIG. 24 is a plan view of a partition blank for forming a partition member according to one embodiment.

FIG. 25 is a plan view of a partition blank for forming a partition member according to one embodiment.

FIG. 26A is a plan view of an outer case blank for forming an outer case member with the partition blanks of FIGS. 24 and 25 attached thereto.

FIG. 26B is a plan view of the outer case blank and partition blanks of FIG. 26A folded about line a.

FIG. 26C is a plan view of the outer case blank and partition blanks of FIG. 26A folded about line a and line b.

FIG. 27 is a partially cut-away perspective view of the outer case blank and the partition blanks of FIG. 26C in an expanded condition.

FIG. 28 is a top schematic view of the outer case blank and partition blanks of FIG. 26C in an expanded condition.

### DETAILED DESCRIPTION

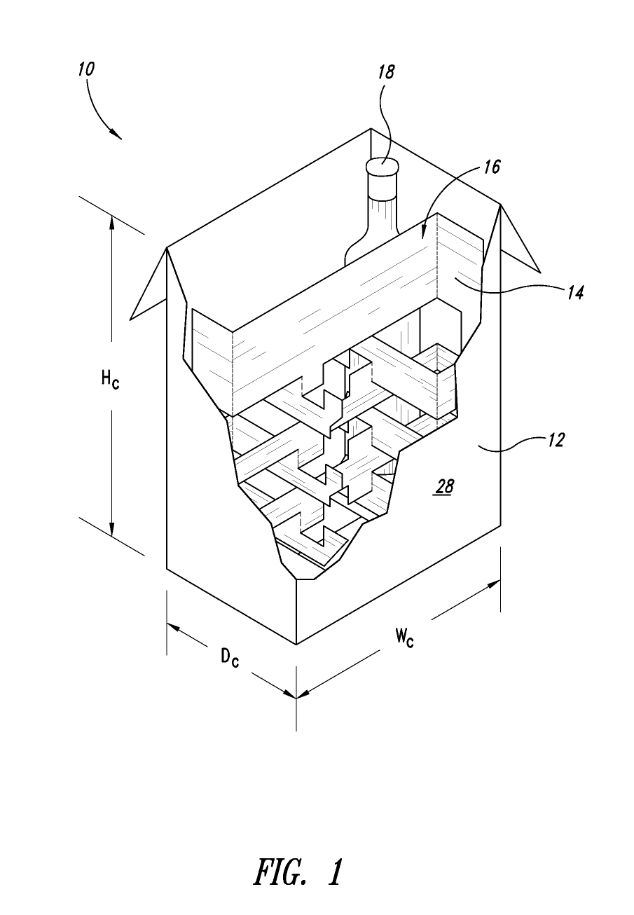

FIG. 1 illustrates one embodiment of a partitioned container 10 having an interior volume defined by a container height Hc, width We and depth Dc. The partitioned container 10 includes an outer case member 12 and a partition member 14, the partition member 14 dividing the interior of the container 10 into a plurality of cells 16 to receive and separate various articles 18, such as, for example, wine bottles. The cells 16 of the partitioned container 10 are aligned in a number of rows and columns, such as, for example, two rows and three columns as shown. Although the cells 16 of the container 10 are preferably substantially equal to receive articles 18 of like kind, the cells may vary in size and shape from each other and may vary in number.

The partition member 14 is adapted to attach to the outer case member 12 of the partitioned container 10 in a completely flat condition and to erect or expand to the condition shown in FIG. 1 when the outer case member 12 (formed from a conventional outer case blank) is erected in a manner well known in the art. Accordingly, the partition member 14 is automatically and simultaneously erected with the outer case member 12 to partition the container 10 into a plurality of cells 16. Because the partition member 14 and outer case member 12 erect simultaneously, the partition member 14 and outer case member 12 may be shipped together in a substantially flat condition to a filling location for subsequent erection and filling. This is particularly advantageous in reducing the time required to assemble or form partitioned containers at or near a point of use. Furthermore, because the partition member 14 is attachable to the outer case member 12 in a completely flat condition, further efficiencies are gained by reducing the need to fold and/or pre-assemble the partition member 14, as is typical of conventional partition members, prior to attachment to the outer case member 12.

Moreover, the illustrated partition member 14 is particularly adapted to receive and separate articles in a form factor or package having reduced material demands. In particular, the partition member 14 of the illustrated embodiment has a height less than the height Hc of the partitioned container 10 and is formed from a unitary partition blank having a partitioning surface area less than is typical of conventional partition members used to partition a similarly dimensioned container. In particular, in some embodiments, the partition member 14 has a partitioning surface effective in partitioning a container into six substantially equal cells 16 with a surface area less than a primary side surface 28 of the partitioned container 10—the primary side surface 28 being the larger of the side surfaces of the container 10 with an area defined by the container height Hc and container width Wc. As such, the partition member 14 is characterized by significant reductions in material costs and also provides effective partitioning in an environmentally friendly manner.

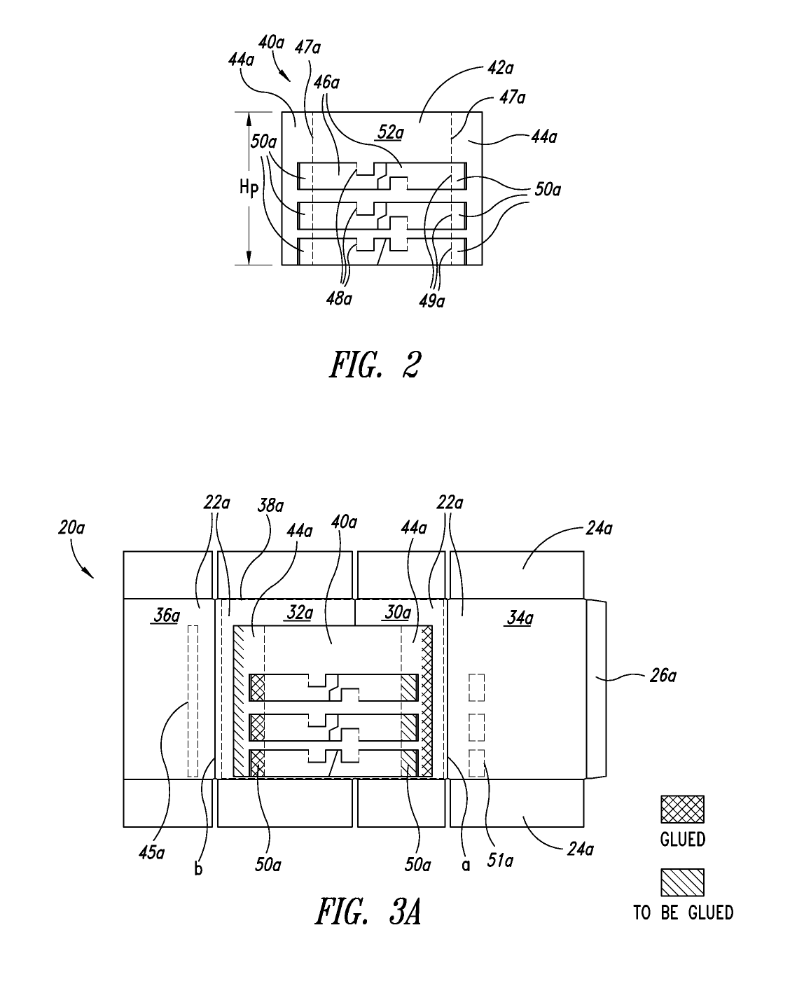

FIGS. 2 through 5, illustrate one embodiment of a partitioned container 10a particularly adapted to receive and separate articles in a form factor or package having reduced material demands and enhanced assembly characteristics. As illustrated in FIG. 2, a partition member for partitioning the container is formed from a unitary partition blank 40a. The blank 40a is preferably made of a single piece of paperboard and formed via a diecutting process, however, those skilled in the art will appreciate that other materials and manufacturing methods may be used to form the partition blank of the present embodiment and various other embodiments described herein.

The unitary partition blank 40a of the illustrated embodiment includes a divider panel 42a located between two divider panel contact regions 44a, the divider panel contact regions 44a being adapted to attach the divider panel 42a to interior surfaces of an outer case of the partitioned container, preferably via adhesive or glue. It will be understood, however, that other attachment means, such as, for example, stapling may be used. Each of the divider panel contact regions 44a are rotatably connected to the divider panel 42a about divider panel rotation axes 47a for rotation from a flat condition (as shown in FIG. 2) to an erected or expanded condition in which the divider panel 42a is substantially perpendicular to the divider panel contact regions 44a. In the erected or expanded condition, the divider panel 42a divides the container into a number of rows while the divider panel contact regions 44a secure the divider panel 42a to side panels of the partitioned container.

The unitary partition blank 40a further includes a plurality of cross members 46a, wherein each cross member 46a is rotatably connected to a cross member contact region 50a for relative rotation therebetween about a contact region rotation axis 49a. Each cross member 46a is also rotatably connected to the divider panel 42a for rotation about a cross member rotation axis 48a from a flat condition (as shown in FIG. 2) to an erected or expanded condition. As cross members 46a transition from the flat condition to the erected or expanded condition, the cross members 46a rotate relative to both the divider panel 42a (about cross member rotation axes 48a) and cross member contact regions 50a (about contact region rotation axes 49a) to subdivide the rows created by the divider panel 42a into a plurality of cells for receiving and separating various articles. The cross member contact regions 50a are adapted to couple to interior surfaces of the container via glue or otherwise, thereby securing ends of the cross members 46a to side panels 22a of the partitioned container.

Rotation of cross members 46a relative to the cross member contact regions 50a and relative to the divider panel 42a, as well as rotation of the divider panel 42a relative to the divider panel contact regions 44a, may be assisted by perforating, creasing, and/or scoring the partition blank 40a about each of the rotation axes 47a, 48a, 49a, as illustrated by broken lines in FIG. 2. In contrast, solid lines indicate where the partition blank 40a is cut or pierced through an entire thickness of the partition blank 40a. For example, apart from the cross member rotation axes 48a, the outer profile or contour of each cross member 46a and corresponding cross member contact region 50a is completely separated from surrounding material of the partition blank 40a.

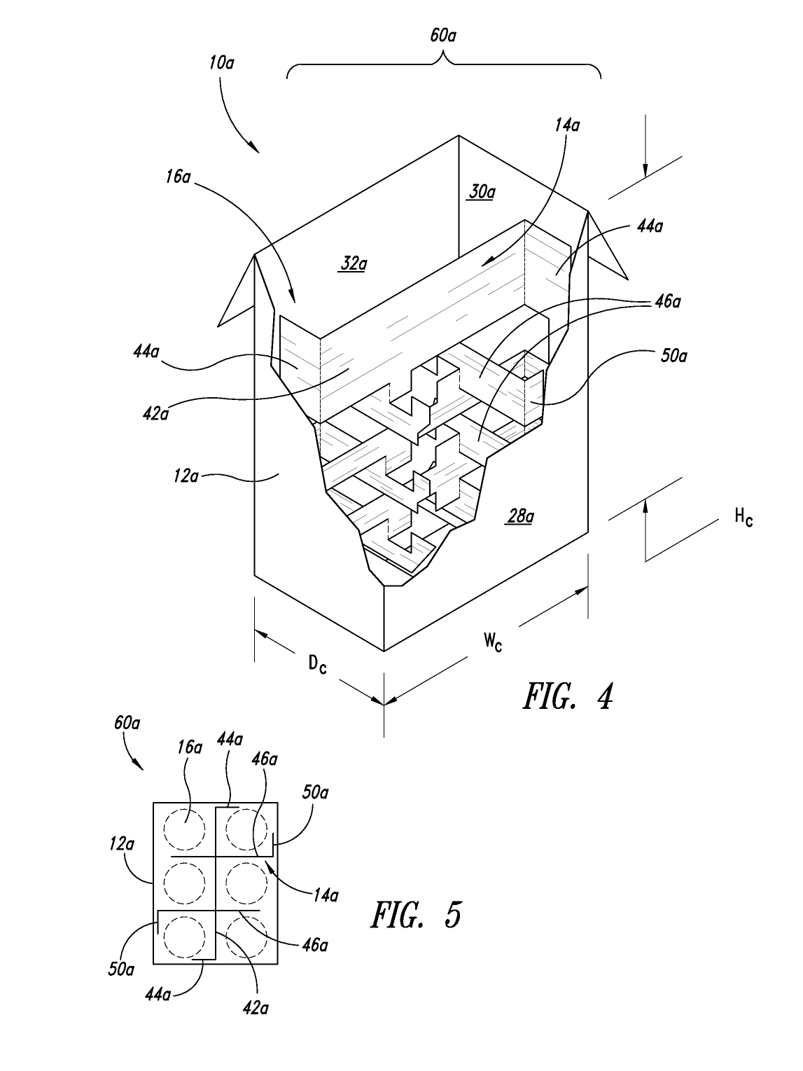

The unitary partition blank 40a has a partition surface 52a divided into contacting regions defined by those areas that are adapted to contact a surface of the container to be partitioned (i.e., the divider panel contact regions 44a and the cross member contact regions 50a) and partitioning regions defined by those areas that are not adapted to contact the surface of the container (i.e., the divider panel 42a and cross members 46a) when the container is erected. The partitioning regions of the partition surface 52a (i.e., the partition surface 52a less all contact regions) form an area which is equal to or less than an area of a primary side surface 28a of the container to be partitioned—the primary side surface 28a (with reference to FIG. 4) being the larger of the side surfaces of the container with an area defined by the container height Hc and container width Wc. In this manner, the partition is particularly suited for effectively dividing a container with a minimal amount of material. For example, for a partitioned container with a height Hc of approximately 12 inches, width Wc of approximately 9 inches, and a depth Dc of approximately 6, the partitioning regions of the partition surface 52a for partitioning the container into six cells has an area less than 108 square inches (Wc·Hc). Conversely, a conventional partition of comparable height having partition members spanning the full width Wc and depth Dc of the container would require at least 252 square inches of material (2·Dc·Hc+Wc·Hc) or approximately two and one-third times more material for partitioning a similarly dimensioned container. As such, the present invention results in reduced material costs and a more environmentally friendly partitioned container.

In some embodiments, a height Hp of the partition blank 40a may be less than the height Hc of the container to be formed. Reducing the height Hp of the partition blank 40a leads to further reductions in the amount of material used to effectively partition a container and is therefore particularly advantageous for environmental impact reasons, as well as for reducing material costs.

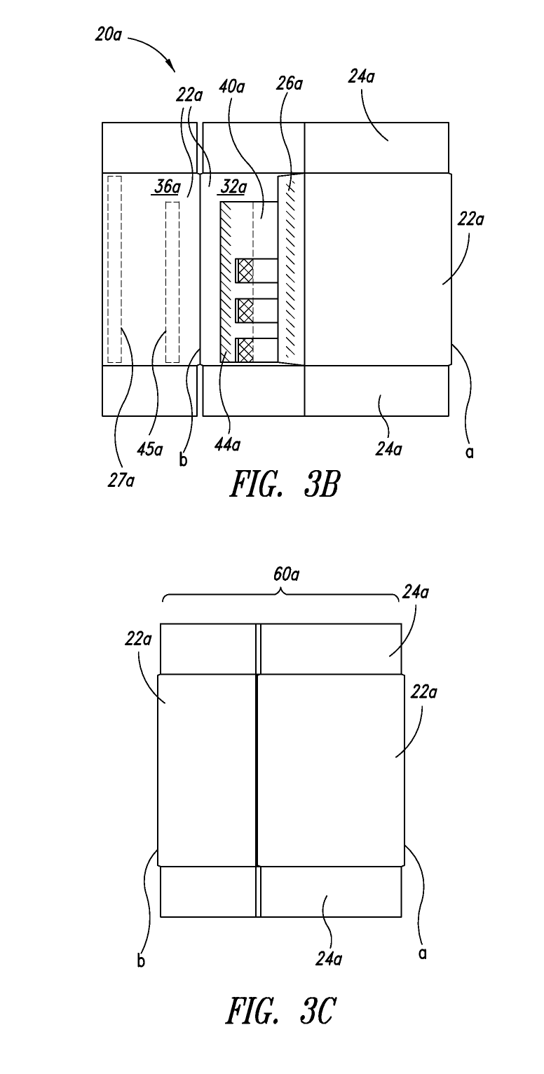

With reference to FIGS. 3A-C, the partition blank 40a is configured to attach to an outer case blank 20a, the outer case blank 20a comprising a conventional configuration including side panels 22a, top and bottom flaps 24a and a glue flap 26a. Although a conventional outer case blank 20a in the form of a Regular Slotted Case (RSC) blank is illustrated, those skilled in the art will appreciate that other outer case blank styles, such as, for example, a Half Slotted Case (HSC) blank or an All Flaps Meet (AFM) blank, may be used with the present embodiment and various other embodiments described herein.

Although the partition blank 40a may be attached to various side panels 22a in a number of different ways, the partition blank 40a is preferably attached to the outer case blank 20a within a partition receiving zone 38a located within the combined area of two adjacent interior side surfaces 30a, 32a of the side panels 22a of the outer case blank 20a. The partition blank 40a is configured to attach to a first side surface 30a of the outer case blank 20a via one of the divider panel contact regions 44a and is configured to attach to a second side surface 32a via a number of the cross member contact regions 50a. The partition blank 40a is preferably attached to the outer case blank 20a with an adhesive or glue, however, other attachment means, such as, for example, stapling may be used.

With the partition blank 40a in the partition receiving zone 38a, the outer case blank 20a may be folded about fold line a (FIG. 3B) and fold line b (FIG. 3C) to substantially enclose the partition blank 40a therein. When folding the outer case blank 20a in this manner, the partition blank 40a is further attached to a third side surface 34a and a fourth side surface 36a of the outer case blank 20a. A first set of broken lines 51a in FIG. 3A illustrate where the third side surface 34a contacts other cross member contact regions 50a of the partition blank 40a and a second set of broken lines 45a illustrate where the fourth side surface 36a contacts the other divider panel contact region 44a. Again, the partition blank 40a is preferably attached to the outer case blank 20a with adhesive or glue. End side panels of the outer case blank 20a are secured together, preferably glued, via glue flap 26a as indicated by broken lines 27a in FIG. 3B to complete an erectable container structure 60a that is configured to erect or expand from a flat condition, wherein the partition blank 40a remains substantially flat, to an expanded condition, wherein the partition blank 40a is erected to create partitioned cells. In other words, the partition blank 40a is automatically and simultaneously erected with the outer case to partition the formed container into a plurality of cells.

It will be appreciated by those skilled in the art that the completed erectable container structure 60a described above, as well as other erectable container structures described hereinafter, may be formed via a single pass of an outer case blank 20a and one or more respective partition blanks 40a through a machine designed to perform both gluing and folding, sometimes referred to as “folder-gluers.” In this manner, numerous erectable container structures 60a may be formed rapidly and efficiently, each erectable container structure 60a being formed in a flat condition for subsequent shipment to a filling location.

FIGS. 4 and 5 illustrate the erectable container structure 60a in the expanded condition with the partition 14a shown dividing the outer case 12a into six cells 16a to receive and effectively separate various articles. As shown, the cross members 46a attach to an interior surface of the outer case 12a and extend across the divider panel 42a and terminate between the divider panel 42a and an opposing interior surface of the outer case 12a. In this manner, end portions of the cross members 46a extend partially across the depth Dc of the container to form the cells 16a and to prevent contact between adjacent articles in a reduced form that requires relatively less material than would otherwise be required of cross members that extend entirely from one side surface of the container to the other.

Although the illustrated embodiment includes six cross members 46a, more or fewer cross members 46a may be used to partition the container 10a. For example, two cross members may be used to partition the container 10a into six cells. In addition, cross members 46a may be selectively located throughout the height Hc of the partitioned container 10a and may vary in size and shape to separate articles of various profiles and/or protect different areas on such articles, such as, for example, labels of a wine bottle.

FIGS. 6 through 10 illustrate another embodiment of a partitioned container 10b for receiving and separating articles. As illustrated in FIG. 6, a partition member for partitioning the container is formed from a unitary partition blank 40b preferably diecut from a single piece of paperboard having two divider panels 42b separated by a single divider panel contact region 44b. The divider panel contact region 44b is also adapted to attach the divider panels 42b to an interior surface of an outer case of the partitioned container, preferably via adhesive or glue. The divider panel contact region 44b is rotatably connected to the divider panels 42b about two separate divider panel rotation axes 47b for rotation from a flat condition (as shown in FIG. 6) to an erected or expanded condition in which each divider panel 42b is substantially perpendicular to the divider panel contact region 44b. Thus, in the erected or expanded condition, the divider panels 42b (each divider panel 42b parallel and offset from the other) divide the container into a number of rows while the divider panel contact region 44b secures the divider panels 42b to a side panel of the container.

The unitary partition blank 40b further includes a plurality of cross members 46b, wherein each cross member 46b is rotatably connected to a cross member contact region 50b for relative rotation therebetween about a contact region rotation axis 49b. Each cross member 46b is also rotatably connected to one of the divider panels 42b for rotation about a cross member rotation axis 48b from a flat condition (as shown in FIG. 6) to an erected or expanded condition. As cross members 46b transition from the flat condition to the erected or expanded condition, the cross members 46b rotate relative to the divider panels 42b (about cross member rotation axes 48b) and the cross member contact regions 50b (about contact region rotation axes 49b) to subdivide rows created by the divider panels 42b into a plurality of cells for receiving and separating various articles. The cross member contact regions 50b are adapted to couple to interior surfaces of the container via glue or otherwise, thereby securing ends of the cross members 46b to side panels 22b of the partitioned container.

Similar to the earlier discussion, rotation of cross members 46b relative to the cross member contact regions 50b and relative to the divider panels 42b, as well as rotation of the divider panels 42b relative to the divider panel contact region 44b, may be assisted by perforating, creasing, and/or scoring the partition blank 40b about each of the rotation axes 47b, 48b, 49b, as illustrated by broken lines. In contrast, solid lines indicate where the partition blank 40b is cut or pierced through an entire thickness of the partition blank 40b. For example, apart from the cross member rotation axes 48b, the outer profile or contour of each cross member 46b and corresponding cross member contact region 50b is completely separated from surrounding material of the partition blank 40b.

With continued reference to FIG. 6, the unitary partition blank 40b has a partition surface 52b divided into contacting regions defined by those areas that are adapted to contact a surface of the container to be partitioned (i.e., the divider panel contact region 44b and the cross member contact regions 50b) and partitioning regions defined by those areas that are not adapted to contact the surface of the container (i.e., the divider panels 42b and the cross members 46b) when the container is erected. The partitioning regions of the partition surface 52b form an area which is equal to or less than twice an area of a primary side surface 28b (with reference to FIG. 9) of the container to be formed, and thus form an efficient partitioning structure in terms of material utilization. For example, for a partitioned container with a height Hc of approximately 12 inches, a width Wc of approximately 12 inches, and a depth Dc of approximately 9, the partitioning regions of the partition surface 52b for partitioning the container into twelve cells has an area less than 288 square inches (2·Wc·Hc). Conversely, a conventional partition of comparable height having partition members spanning the full width Wc and depth Dc of the container would require at least 504 square inches of material (2·Dc·Hc+2·Wc·Hc) or approximately one and three-quarter times more material for partitioning a similarly dimensioned container. As such, the present invention results in reduced material costs and a more environmentally friendly partitioned container.

In some embodiments, a height Hp of the partition blank 40b may be less than the height Hc of the container to be partitioned. Reducing the height Hp of the partition blank 40b leads to further reductions in the amount of material used to effectively partition a container and is therefore particularly advantageous for environmental impact reasons, as well as for reducing material costs.

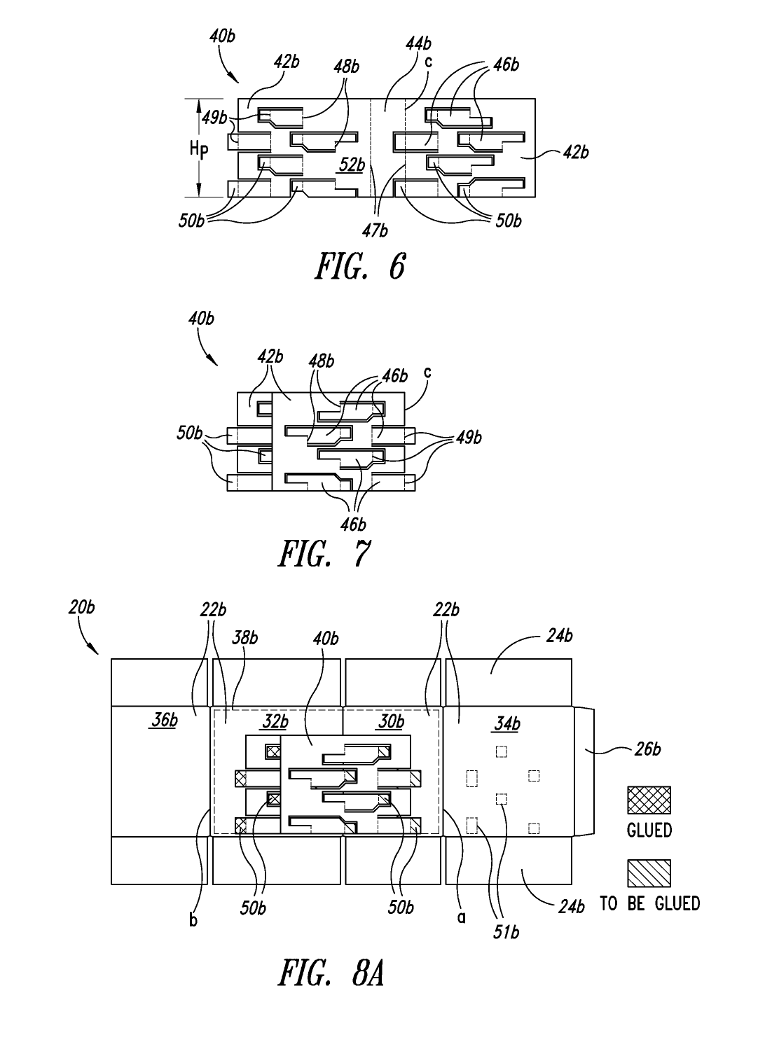

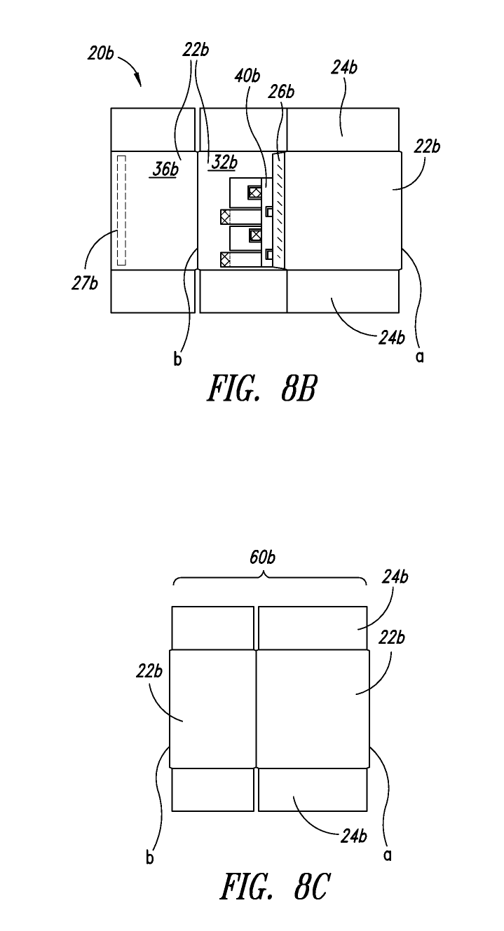

According to this illustrated embodiment, the partition blank 40b is foldable about fold line c from an entirely flat condition (FIG. 6) to a substantially flat folded condition (FIG. 7). As shown in FIG. 8A, the partition blank 40b is configured to attach to an outer case blank 20b (the outer case blank comprising a conventional configuration including side panels 22b, top and bottom flaps 24b and a glue flap 26b) in the folded flat condition preferably within partition receiving zone 38b, the partition receiving zone 38b being located within the combined area of two adjacent interior side surfaces 30b, 32b of the outer case blank 20b. In this embodiment, the folded partition blank 40b is configured to attach to the first side surface 30b of the outer case blank 20b via the divider panel contact region 44b and is configured to attach to the second side surface 32b via a number of the cross member contact regions 50b, the partition blank 40b preferably being attached via adhesive or glue.

As illustrated in FIGS. 8A-8C, with the partition blank 40b in the partition receiving zone 38b, the outer case blank 20b may be folded about fold line a (FIG. 8B) and fold line b (FIG. 8C) to substantially enclose the partition blank 40b therein. When folding the outer case blank 20b in this manner, the partition blank 40b is attached, preferably via adhesive or glue, to a third side surface 34b of the outer case blank 20b. Broken lines 51b in FIG. 8A illustrate where the third side surface 34b contacts other cross member contact regions 50b of the partition blank 40b. End side panels of the outer case blank 20b are secured together, preferably glued, via glue flap 26b as indicated by broken lines 27b in FIG. 8B to complete an erectable container structure 60b that is configured to erect or expand from a flat condition, wherein the partition blank 40b remains substantially flat, to an expanded condition, wherein the partition blank 40b is erected to create partitioned cells. In other words, the partition blank 40b is automatically and simultaneously erected with the outer case to partition the formed container into a plurality of cells.

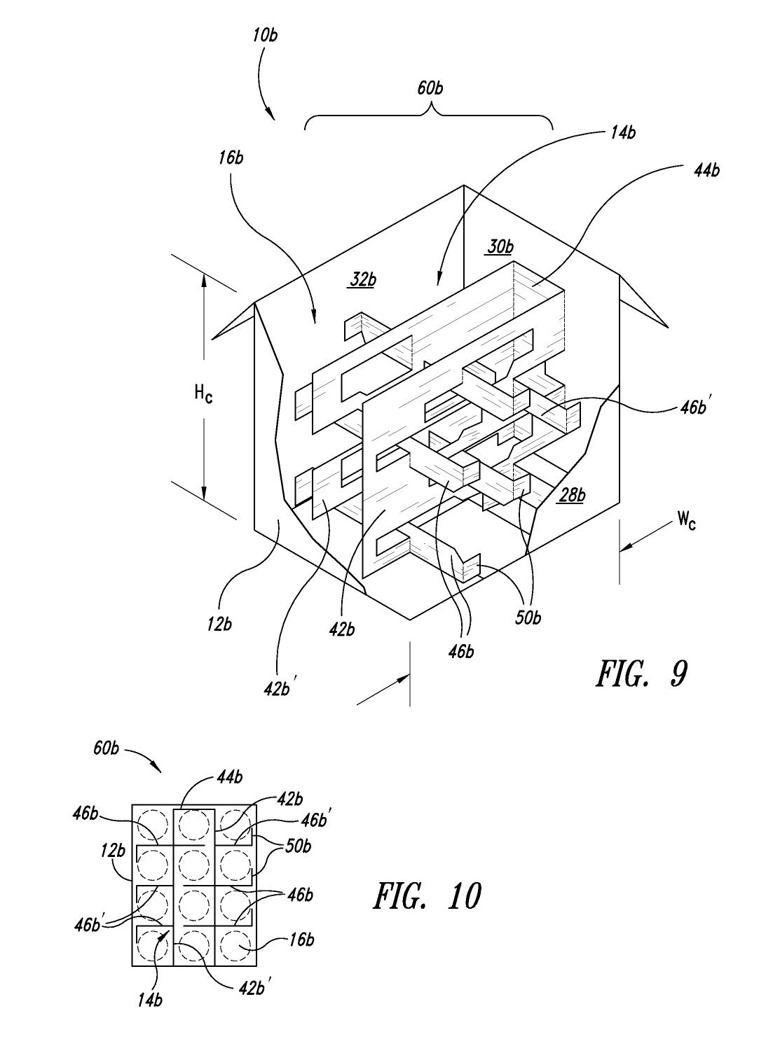

FIGS. 9 and 10 illustrate the erectable container structure 60b in the expanded condition, wherein the partition 14b is shown dividing the outer case 12b into twelve cells 16b. As shown, at least some of the cross members 46b attach to an interior surface of the outer case 12b, extend across a first divider panel 42b and terminate between the first divider panel 42b and the second divider panel 42b′. In this manner, end portions of a number of the cross members 46b extend partially across the space between the divider panels 42b, 42b′ to form some of the cells 16b and to prevent contact between adjacent articles in a reduced form that requires relatively less material than would otherwise be required of cross members that extend completely between divider panels. Other cross members 46b′ attach to an interior surface of the outer case 12b and extend to and terminate at the divider panels 42b, 42b′.

Although the illustrated embodiment includes twelve cross members 46b, 46b′, more or fewer cross members 46b, 46b′ may be used to partition the container 10b. For example, six cross members 46b, 46b′ may be used to partition the container 10b into twelve cells. As in other previously described embodiments, the cross members 46b, 46b′ may be selectively located throughout the height Hc of the partitioned container and may vary in size and shape to separate articles of various profiles and/or to protect different areas on such articles.

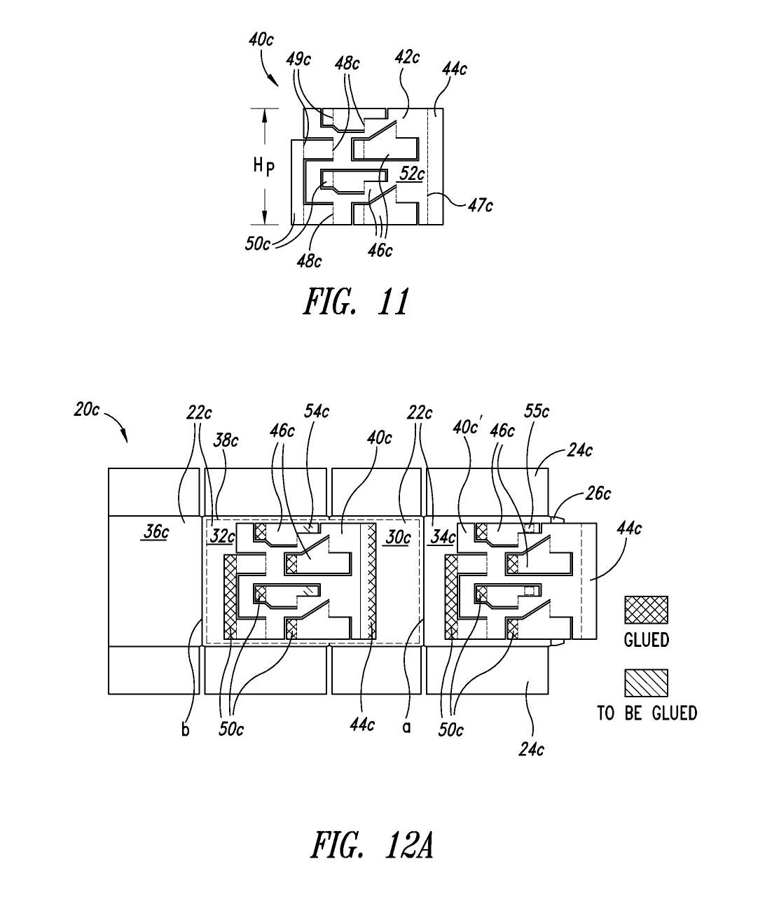

FIGS. 11 through 14 illustrate yet another embodiment of a partitioned container 10c for receiving and separating articles. As illustrated in FIG. 11, a first or primary partition member for partitioning the container is formed from a first or primary unitary partition blank 40c preferably diecut from a single piece of paperboard having a divider panel 42c and a divider panel contact region 44c. The divider panel contact region 44c is adapted to attach the divider panel 42c to an interior surface of an outer case of the partitioned container, preferably via adhesive or glue. The divider panel contact region 44c is also rotatably connected to the divider panel 42c about a divider panel rotation axis 47c for rotation from a flat condition (as shown in FIG. 11) to an erected or expanded condition in which the divider panel 42c is substantially perpendicular to the divider panel contact region 44c. Thus, in the erected or expanded condition, the divider panel 42c divides the container into a number of rows while the divider panel contact region 44c secures the divider panel 42c to a side panel of the container.

The first or primary unitary partition blank 40c further includes a plurality of cross members 46c, wherein each cross member 46c is rotatably connected to a cross member contact region 50c for relative rotation therebetween about a contact region rotation axis 49c. Each cross member 46c is also rotatably connected to the divider panel 42c for rotation about a cross member rotation axis 48c from a flat condition (as shown in FIG. 11) to an erected or expanded condition. As the cross members 46c transition from the flat condition to the erected or expanded condition, the cross members 46c rotate relative to the divider panel 42c (about cross member rotation axes 48c) and the cross member contact regions 50c (about contact region rotation axes 49c) to subdivide at least one row created by the divider panel 42c into a plurality of cells for receiving and separating various articles. The cross member contact regions 50c are adapted to couple to an interior surface of the container via glue or otherwise, thereby securing ends of the cross members 46c to a side panel 22c of the partitioned container.

Similar to the earlier discussion, rotation of cross members 46c relative to the cross member contact regions 50c and relative to the divider panel 42c, as well as rotation of the divider panel 42c relative to the divider panel contact region 44c, may be assisted by perforating, creasing, and/or scoring the partition blank 40c about each of the rotation axes 47c, 48c, 49c, as illustrated by broken lines in FIG. 11. In contrast, solid lines indicate where the partition blank 40c is cut or pierced through an entire thickness of the partition blank 40c. For example, apart from the cross member rotation axes 48c, the outer profile or contour of each cross member 46c and corresponding cross member contact region 50c is completely separated from surrounding material of the partition blank 40c.

With reference to FIG. 11, the first or primary partition blank 40c has a partition surface 52c divided into contacting regions defined by those areas that are adapted to contact a surface of the container to be partitioned (i.e., the divider panel contact region 44c and the cross member contact regions 50c) and partitioning regions defined by those areas that are not adapted to contact the surface of the container (i.e., the divider panel 42c and the cross members 46c) when the container is erected. The partitioning regions of the partition surface 52c of the first or primary partition blank 40c form an area which is equal to or less than an area of a primary side surface 28c (with reference to FIG. 13) of the container to be formed, and thus form an efficient partitioning structure in terms of material utilization.

In some embodiments, a height Hp of the first or primary partition blank 40c is less than the height Hc of the container to be partitioned. Reducing the height Hp of the partition blank 40c leads to further reductions in the amount of material used to effectively partition a container and is therefore particularly advantageous for environmental impact reasons, as well as for reducing material costs.

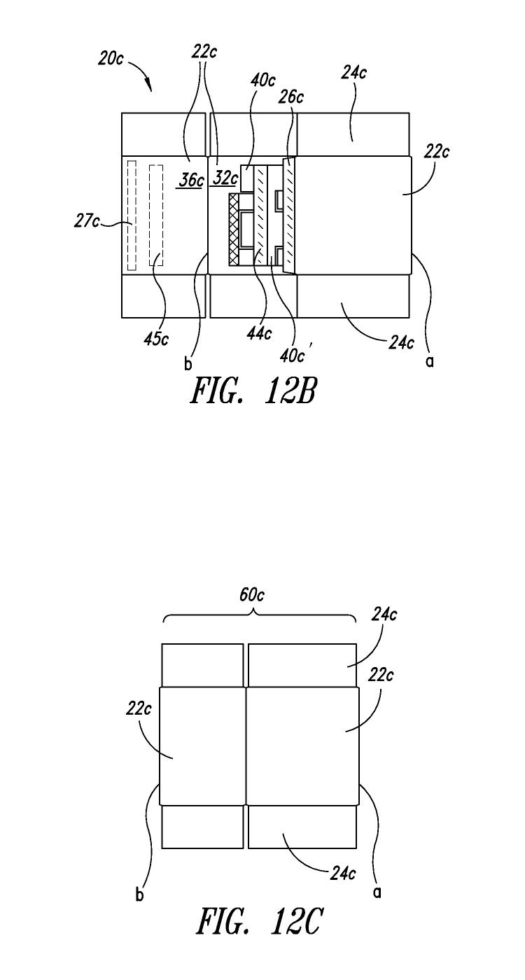

With reference to FIGS. 12A-C, the first or primary partition blank 40c is configured to attach to an outer case blank 20c (the outer case blank 20c comprising a conventional configuration including side panels 22c, top and bottom flaps 24c and a glue flap 26c) preferably within a partition receiving zone 38c—the partition receiving zone 38c being located within the combined area of two adjacent interior side surfaces 30c, 32c of the outer case blank 20c. The first or primary partition blank 40c is attached, preferably via adhesive or glue, in a flat condition to a first side surface 30c of the outer case blank 20c via the divider panel contact region 44c and attached, preferably via adhesive or glue, to a second side surface 32c via a number of the cross member contact regions 50c. According to the illustrated embodiment, a second partition blank 40c′ substantially identical to the first or primary partition blank 40c for forming a second partition member 14c′ (FIG. 13) is similarly attached in a flat condition to a third side surface 34c of the outer case blank 20c via a number of the cross member contact regions 50c of the second partition blank 40c′; however, the second partition blank 40c′ may alternatively be placed within the partition receiving zone 38c and/or attached to the first partition blank 40c for subsequent attachment to the third side surface 34c of the outer case blank 20c when the outer case blank 20c is folded, as described below.

With at least the first partition blank 40c in the partition receiving zone 38c, the outer case blank 20c may be folded about fold line a (FIG. 12B) and fold line b (FIG. 12C) to substantially enclose the first partition blank 40c and the second partition blank 40c′ therein. When folding the outer case blank 20c in this manner the second partition blank 40c′ is attached, preferably via adhesive or glue, to a fourth side surface 36c of the outer case blank 20c. Broken lines 45c in FIG. 12B illustrate where the fourth side surface 36c contacts the divider panel contact region 44c of the second partition blank 40c′. In addition, an end portion 54c of one or more of the cross members 46c of the first partition blank 40c may be attached to corresponding cross members 46c of the second partition blank 40c′. For example, as illustrated in FIG. 12A, the end portion 54c of each of two cross members 46c may attach to other corresponding cross members 46c at the location illustrated by broken lines 55c. In this manner, some cross members 46c are attached together to erect simultaneously when transitioning to the erected or expanded condition.

End side panels of the outer case blank 20c are secured together, preferably glued, via glue flap 26c as indicated by broken lines 27c in FIG. 12B to complete an erectable container structure 60c that is configured to erect or expand from a flat condition, wherein both of the first partition blank 40c and the second partition blank 40c′ remain flat, to an expanded condition, wherein the first and the second partition blanks 40c, 40c′ are erected to form partitioned cells—the first and the second partition blanks 40c, 40c′ cooperating with each other to create the plurality of cells. In other words, the partition blanks 40c, 40c′ are automatically and simultaneously erected with the outer case to partition the formed container into a plurality of cells.

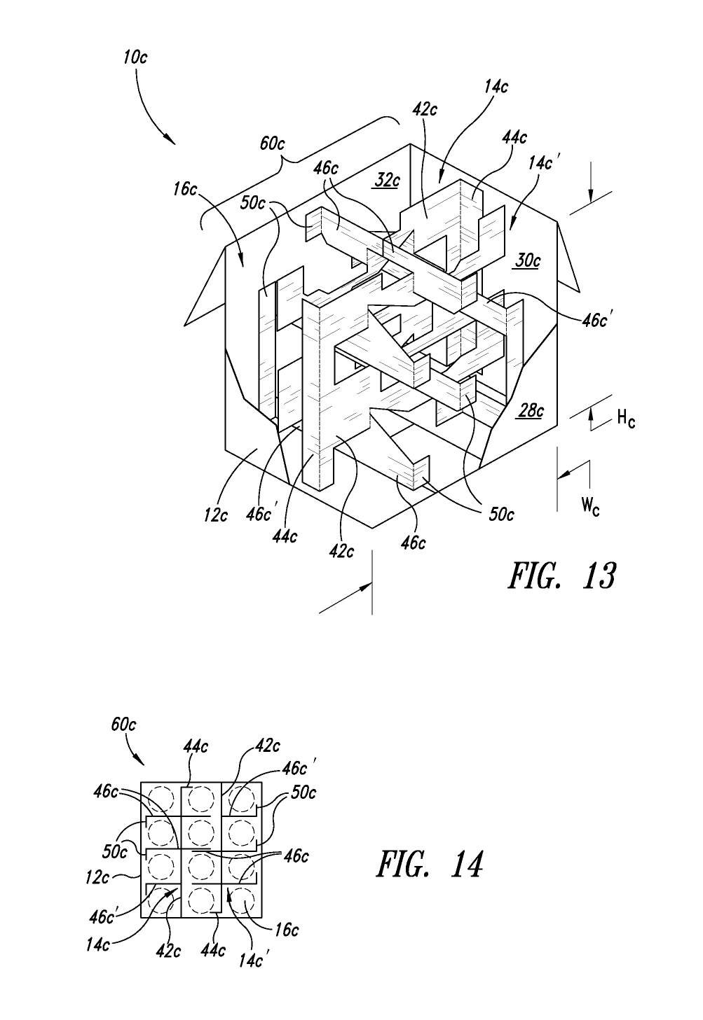

FIGS. 13 and 14 illustrate the erectable container structure 60c in the expanded condition with partitions 14c, 14c′ shown dividing the outer case 12c into twelve cells 16c. As shown, at least some of the cross members 46c of the first or second partition 14c, 14c′ attach to an interior surface of the outer case 12c and extend across the divider panel 42c of the first or second partition 14c, 14c′ and terminate between the divider panel 42c of the first partition 14c and the divider panel 42c of the second partition 14c′. In this manner, end portions of some of the cross members 46c extend partially across the space between the divider panels 42c to form a number of the cells 16c and to prevent contact between adjacent articles in a reduced form that requires relatively less material than would otherwise be required of cross members that extend completely between divider panels. Other cross members 46c′ of the first or second partition member 14c, 14c′ attach to an interior surface of the outer case 12c and extend to and terminate at the divider panel 42c.

Although the illustrated embodiment includes five cross members 46c, 46c′ on each partition 14c, 14c′, more or fewer cross members may be used to partition the container 10c. For example, three cross members on each partition 14c, 14c′ may be used to partition the container 10c into twelve cells. In addition, the cross members 46c, 46c′ may be selectively located throughout the height Hc of the container 10c and may vary in size and shape to separate articles of various profiles and/or protect different areas of such articles.

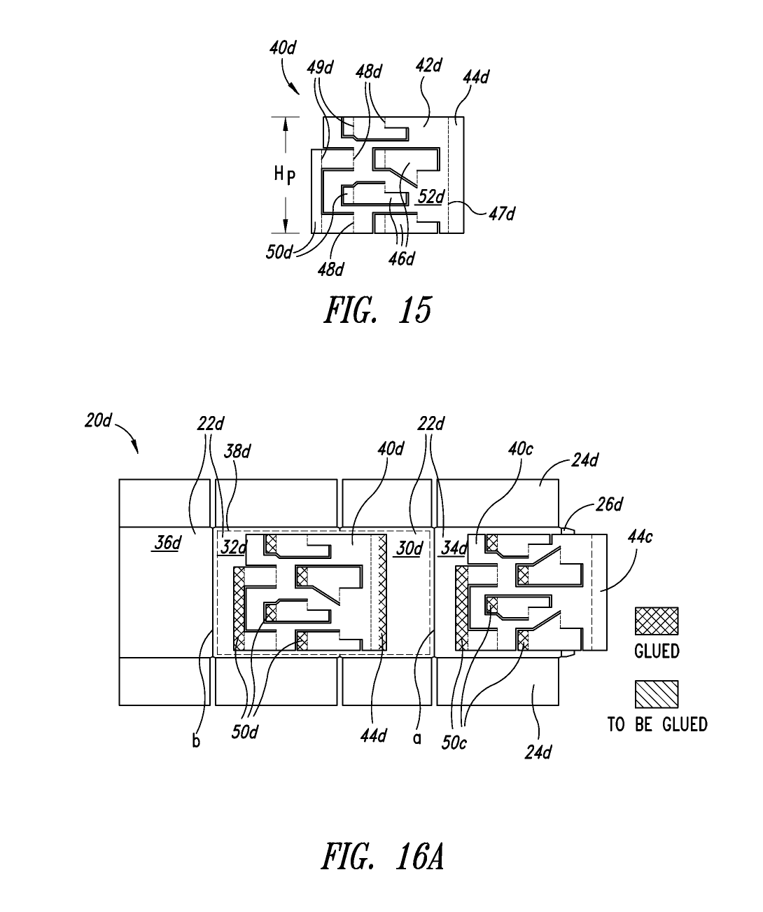

FIGS. 15 through 18 illustrate yet another embodiment of a partitioned container 10d for receiving and separating articles. As illustrated in FIG. 15, a secondary partition member is formed from a secondary unitary partition blank 40d preferably diecut from a single piece of paperboard having similar features to the first or primary partition blank 40c described above, such as a divider panel 42d, a divider panel contact region 44d, cross members 46d, cross member contact regions 50d, and corresponding rotation axes 47d, 48d, 49d.

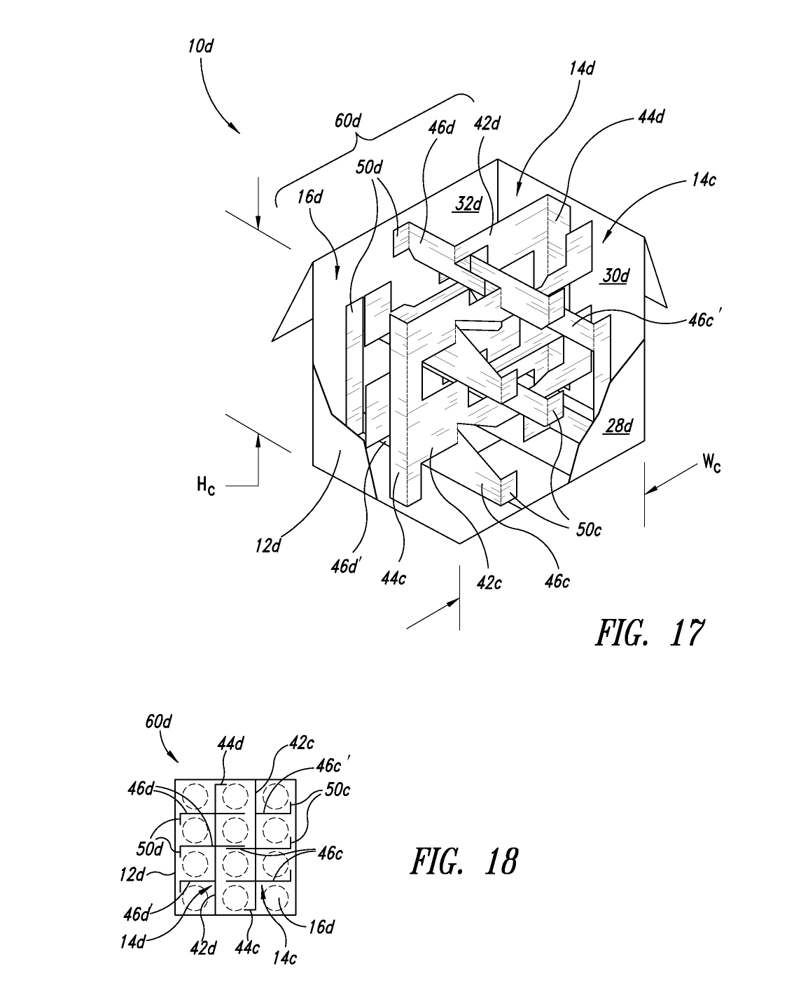

Moreover, the secondary partition blank 40d has a partition surface 52d divided into contacting regions defined by those areas that are adapted to contact a surface of the container to be partitioned (i.e., the divider panel contact region 44d and the cross member contact regions 50d) and partitioning regions defined by those areas that are not adapted to contact the surface of the container (i.e., the divider panel 42d and the cross members 46d) when the container is erected. The partitioning regions of the partition surface 52d of the secondary partition blank 40d form an area which is equal to or less than an area of a primary side surface 28d (with reference to FIG. 17) of the container to be formed. Accordingly, when used in combination with the primary partition blank 40c of FIG. 11, a combined area of the partitioning regions of the partition surface 52c of the primary partition blank 40c and of the partition surface 52d of the secondary partition blank 40d is less than twice an area of the primary side surface 28d of the container 10d to be formed. The primary and secondary partition blanks 40c, 40d thereby cooperate to form an efficient partitioning structure in terms of material utilization.

In some embodiments, a height Hp of each of the primary and secondary partition blanks 40c, 40d is less than the height Hc of the container to be partitioned. Reducing the height Hp of each partition blank 40c, 40d leads to further reductions in the amount of material used to effectively partition a container and is therefore particularly advantageous for environmental impact reasons, as well as for reducing material costs.

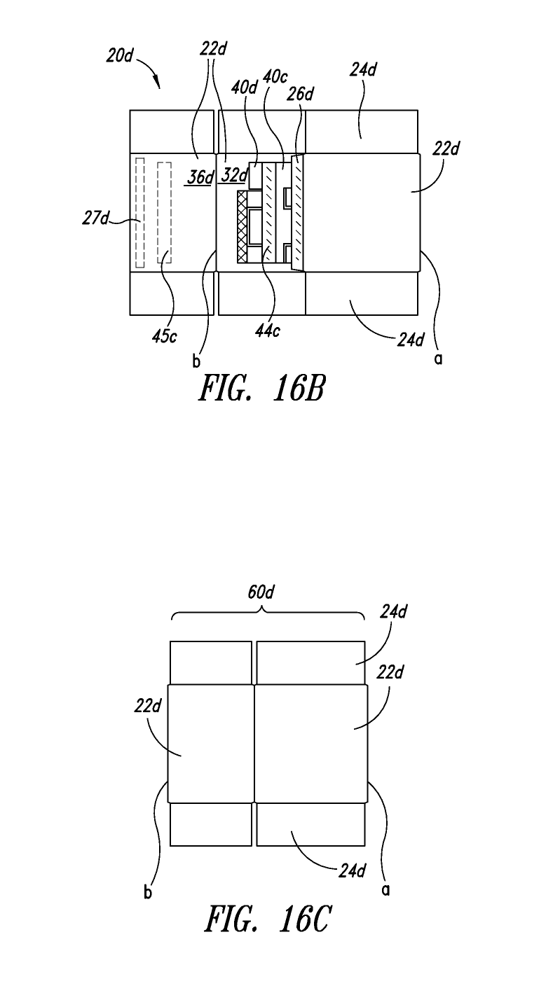

With reference to FIGS. 16A-C, the secondary partition blank 40d is configured to attach to an outer case blank 20d (the outer case blank 20d comprising a conventional configuration including side panels 22d, top and bottom flaps 24d and a glue flap 26d) preferably within a partition receiving zone 38d—the partition receiving zone 38d being located within the combined area of two adjacent interior side surfaces 30d, 32d of the outer case blank 20d. The secondary partition blank 40d is attached, preferably via adhesive or glue, in a flat condition to a first side surface 30d of the outer case blank 20d via the divider panel contact region 44d and attached, preferably via adhesive or glue, to a second side surface 32d via a number of the cross member contact regions 50d. The primary partition blank 40c is similarly attached in a flat condition to a third side surface 34d of the outer case blank 20d via a number of the cross member contact regions 50c; however, the primary partition blank 40c may alternatively be placed within the partition receiving zone 38d for attachment to the third side surface 34d of the outer case blank 20d when the outer case blank 20d is subsequently folded, as described below.

With at least the secondary partition blank 40d in the partition receiving zone 38d, the outer case blank 20d may be folded about fold line a (FIG. 16B) and fold line b (FIG. 16C) to substantially enclose the primary partition blank 40c and the secondary partition blank 40d therein. When folding the outer case blank 20d in this manner the primary partition blank 40c is attached, preferably via adhesive or glue, to a fourth side surface 36d of the outer case blank 20d. Broken lines 45c in FIG. 16B illustrate where the fourth side surface 36d contacts the divider panel contact region 44c of the primary partition blank 40c. End side panels of the outer case blank 20d are secured together, preferably glued, via glue flap 26d as indicated by broken lines 27d in FIG. 16B to complete an erectable container structure 60d that is configured to erect or expand from a flat condition, wherein both of the primary partition blank 40c and the secondary partition blank 40d remain flat, to an expanded condition, wherein the primary and the secondary partition blanks 40c, 40d are erected to form partitioned cells—the primary and the secondary partition blanks 40c, 40d cooperating with each other to create the plurality of cells. In other words, the partition blanks 40c, 40d are automatically and simultaneously erected with the outer case to partition the formed container into a plurality of cells.

FIGS. 17 and 18 illustrate the erectable container structure 60d in the expanded condition with partitions 14c, 14d shown dividing the outer case 12d into twelve cells 16d. As shown, at least some of the cross members 46c of the primary partition 14c attach to an interior surface of the outer case 12d and extend across the divider panel 42c of the primary partition 14c and terminate between the divider panel 42c of the primary partition 14c and the divider panel 42d of the secondary partition 14d. In this manner, end portions of some of the cross members 46c extend partially across the space between the divider panels 42c, 42d to form a number of the cells 16d and to prevent contact between adjacent articles in a reduced form that requires relatively less material than would otherwise be required of cross members that extend completely between divider panels. Other cross members 46c′ of the primary partition member 14c attach to an interior surface of the outer case 12c and extend to and terminate at the divider panel 42c of the primary partition member 14c. Similar characteristics apply to the cross members 46d, 46d′ of the secondary partition 14d.

Although the illustrated embodiment includes five cross members 46c, 46c′, 46d, 46d′ on each partition 14c, 14d, more or fewer cross members may be used to partition the container 10d. For example, three cross members on each partition 14c, 14d may be used to partition the container 10d into twelve cells. In addition, the cross members 46c, 46c′, 46d, 46d′ may be selectively located throughout the height Hc of the container 10d and may vary in size and shape to separate articles of various profiles and/or protect different areas of such articles.

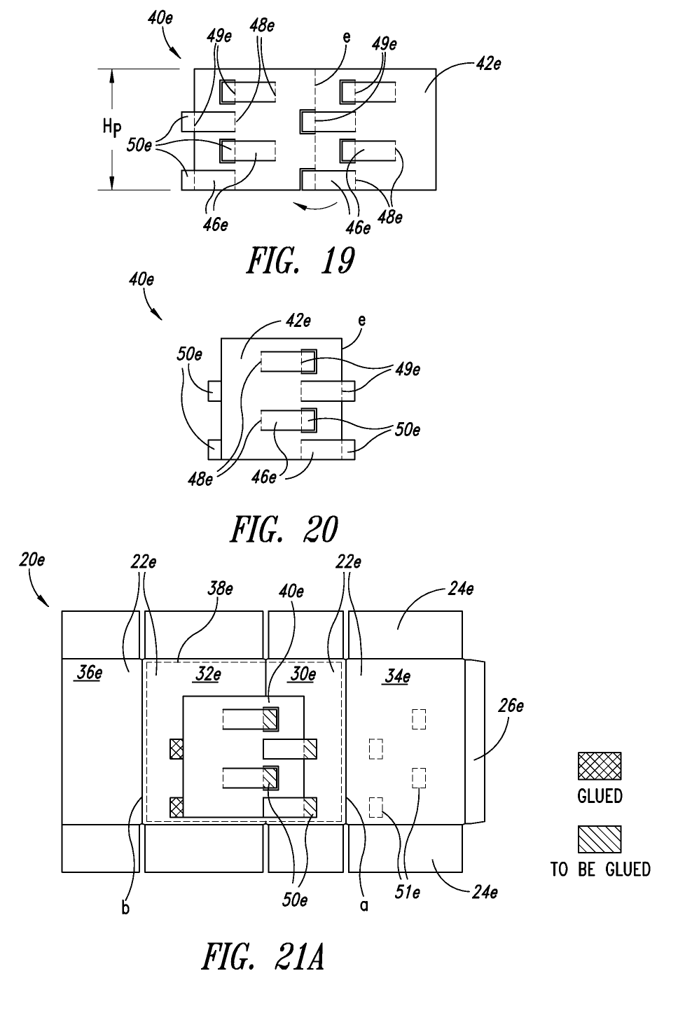

FIGS. 19 through 23 illustrate yet another embodiment of a partitioned container 10e for receiving and separating articles. As illustrated in FIGS. 19 and 20, a partition member for partitioning the container is formed from a unitary partition blank 40e preferably diecut from a single piece of paperboard having a divider panel 42e foldable about line e from an entirely flat condition (FIG. 19) to a substantially flat folded condition (FIG. 20). In the substantially flat folded condition, the divider panel 42e is adapted to divide a container into a number of rows.

The unitary partition blank 40e further includes a plurality of cross members 46e, wherein each cross member 46e is rotatably connected to a cross member contact region 50e for relative rotation therebetween about a contact region rotation axis 49e. Each cross member 46e is also rotatably connected to the divider panel 42e for rotation about a cross member rotation axis 48e from a flat condition (as shown in FIG. 20) to an erected or expanded condition. As the cross members 46e transition from the flat condition to the erected or expanded condition, the cross members 46e rotate relative to the divider panel 42e (about cross member rotation axes 48e) and the cross member contact regions 50e (about contact region rotation axes 49e) to subdivide rows created by the divider panel 42e into a plurality of cells for receiving and separating various articles. The cross member contact regions 50e are adapted to couple to interior surfaces of the container via glue or otherwise, thereby securing ends of the cross members 46e to side panels 22e of the partitioned container.

Similar to the earlier discussion, rotation of cross members 46e relative to the cross member contact regions 50e and relative to the divider panel 42e may be assisted by perforating, creasing, and/or scoring the partition blank 40e about each of the rotation axes 48e, 49e, as illustrated by broken lines in FIG. 19. In contrast, solid lines indicate where the partition blank 40e is cut or pierced through an entire thickness of the partition blank 40e. For example, apart from the cross member rotation axes 48e, the outer profile or contour of each cross member 46e and corresponding cross member contact region 50e is completely separated from surrounding material of the partition blank 40e.

In some embodiments, a height Hp of the foldable partition blank 40e is less than the height Hc of the container to be partitioned. Reducing the height Hp of the partition blank 40e leads to further reductions in the amount of material used to effectively partition a container and is therefore particularly advantageous for environmental impact reasons, as well as for reducing material costs.

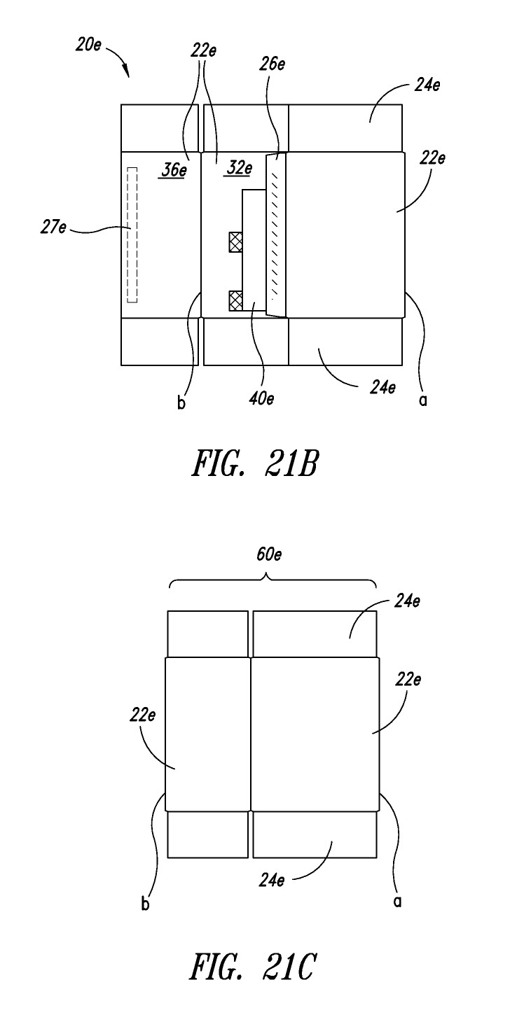

With reference to FIGS. 21A-C, the partition blank 40e is configured to attach to the outer case blank 20e (the outer case blank 20e comprising a conventional configuration including side panels 22e, top and bottom flaps 24e and a glue flap 26e) in the folded condition preferably within partition receiving zone 38e—the partition receiving zone 38e being located within the combined area of two adjacent interior side surfaces 30e, 32e of the outer case blank 20e. In this embodiment, the partition blank 40e is not configured to attach to the first side surface 30e of the outer case blank 20e, but is configured to attach, preferably via adhesive or glue, to the second side surface 32e via a number of the cross member contact regions 50e.

As shown in FIGS. 21A-C, with the partition blank 40e in the partition receiving zone 38e, the outer case blank 20e may be folded about fold line a (FIG. 21B) and fold line b (FIG. 21C) to substantially enclose the partition blank 40e therein. When folding the outer case blank 20e in this manner, the partition blank 40e is attached, preferably via adhesive or glue, to a third side surface 34e of the outer case blank 20e. Broken lines 51e in FIG. 21A illustrate where the third side surface 34e contacts cross member contact regions 50e of the partition blank 40e. End side panels of the outer case blank 20e are secured together, preferably glued, via glue flap 26e as indicated by broken lines 27e in FIG. 21B to complete an erectable container structure 60e that is configured to erect or expand from a flat condition, wherein the partition blank 40e remains substantially flat, to an expanded condition, wherein the partition blank 40e is erected to create partitioned cells. In this manner, the partition blank 40e is automatically and simultaneously erected with the outer case to partition the formed container into a plurality of cells.

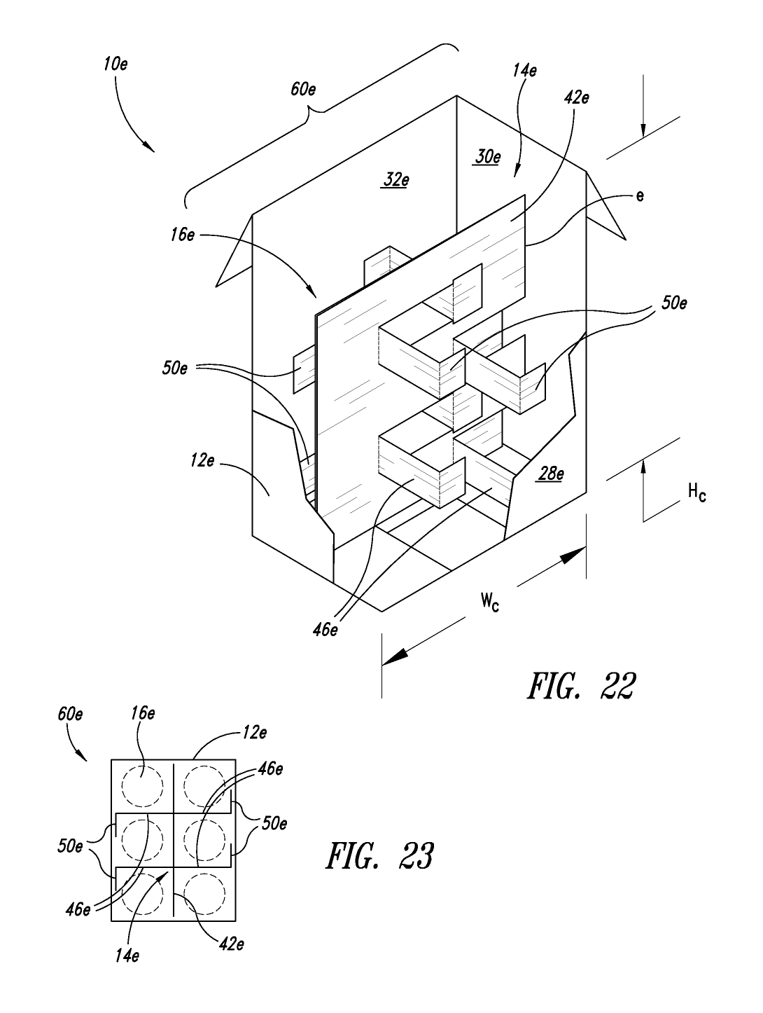

FIGS. 22 and 23 illustrate the erectable container structure 60e in the expanded condition with the partition 14e shown dividing the outer case 12e into six cells 16e. As shown, the cross members 46e attach to an interior surface of the outer case 12e and extend to and terminate at the divider panel 42e.

Although the illustrated embodiment includes eight cross members 46e, more or fewer cross members 46e may be used to partition the container 10e. For example, four cross members 46e may be used to partition the container 10e into six cells. In addition, the cross members 46e may be selectively located throughout the height Hc of the container 10e and may vary in size and shape to separate articles of various profiles and/or protect different areas of such articles.

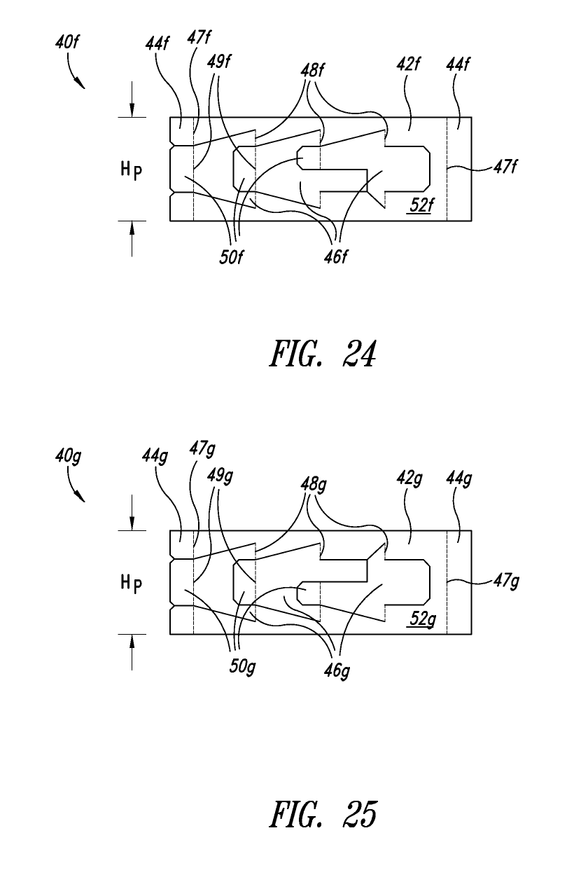

FIGS. 24 through 28 illustrate yet another embodiment of a partitioned container 10f for receiving and separating articles. As illustrated in FIG. 24, a first or primary partition member for partitioning the container is formed from a first or primary unitary partition blank 40f preferably diecut from a single piece of paperboard having a divider panel 42f and two or more divider panel contact regions 44f. The divider panel contact regions 44f are adapted to attach the divider panel 42f to interior surfaces of an outer case of the partitioned container, preferably via adhesive or glue. The divider panel contact regions 44f are also rotatably connected to the divider panel 42f about divider panel rotation axes 47f for rotation from a flat condition (as shown in FIG. 24) to an erected or expanded condition in which the divider panel 42f is substantially perpendicular to the divider panel contact regions 44f. Thus, in the erected or expanded condition, the divider panel 42f divides the container into a number of rows while the divider panel contact regions 44f secure the divider panel 42f to side panels of the container.

The first or primary unitary partition blank 40f further includes a plurality of cross members 46f, wherein each cross member 46f is rotatably connected to a cross member contact region 50f for relative rotation therebetween about a contact region rotation axis 49f. Each cross member 46f is also rotatably connected to the divider panel 42f for rotation about a cross member rotation axis 48f from a flat condition (as shown in FIG. 24) to an erected or expanded condition. As the cross members 46f transition from the flat condition to the erected or expanded condition, the cross members 46f rotate relative to the divider panel 42f (about cross member rotation axes 48f) and the cross member contact regions 50f (about contact region rotation axes 49f) to subdivide at least one row created by the divider panel 42f into a plurality of cells for receiving and separating various articles. The cross member contact regions 50f are adapted to couple to an interior surface of the container via glue or otherwise, thereby securing ends of the cross members 46f to a side panel 22f of the partitioned container.

Similar to the earlier discussion, rotation of cross members 46f relative to the cross member contact regions 50f and relative to the divider panel 42f, as well as rotation of the divider panel 42f relative to the divider panel contact regions 44f, may be assisted by perforating, creasing, and/or scoring the partition blank 40f about each of the rotation axes 47f, 48f, 49f, as illustrated by broken lines in FIG. 24. In contrast, solid lines indicate where the partition blank 40f is cut or pierced through an entire thickness of the partition blank 40f. For example, apart from the cross member rotation axes 48f, the outer profile or contour of each cross member 46f and corresponding cross member contact region 50f is completely separated from surrounding material of the partition blank 40f.

With reference to FIG. 24, the first or primary partition blank 40f has a partition surface 52f divided into contacting regions defined by those areas that are adapted to contact a surface of the container to be partitioned (i.e., the divider panel contact regions 44f and the cross member contact regions 50f) and partitioning regions defined by those areas that are not adapted to contact the surface of the container (i.e., the divider panel 42f and the cross members 46f) when the container is erected. The partitioning regions of the partition surface 52f of the first or primary partition blank 40f form an area which is equal to or less than an area of a primary side surface 28f (with reference to FIG. 27) of the container to be formed, and thus form an efficient partitioning structure in terms of material utilization.

As illustrated in FIG. 25, a secondary partition member is formed from a secondary unitary partition blank 40g preferably diecut from a single piece of paperboard having similar features to the first or primary partition blank 40f described above, such as a divider panel 42g, divider panel contact regions 44g, cross members 46g, cross member contact regions 50g, and corresponding rotation axes 47g, 48g, 49g.

Moreover, the secondary partition blank 40g has a partition surface 52g divided into contacting regions defined by those areas that are adapted to contact a surface of the container to be partitioned (i.e., the divider panel contact regions 44g and the cross member contact regions 50g) and partitioning regions defined by those areas that are not adapted to contact the surface of the container (i.e., the divider panel 42g and the cross members 46g) when the container is erected. The partitioning regions of the partition surface 52g of the secondary partition blank 40g form an area which is equal to or less than an area of a primary side surface 28f (with reference to FIG. 27) of the container to be formed. Accordingly, when used in combination with the primary partition blank 40f of FIG. 24, a combined area of the partitioning regions of the partition surface 52f of the primary partition blank 40f and of the partition surface 52g of the secondary partition blank 40g is equal to or less than twice an area of the primary side surface 28f of the container 10f to be formed. The primary and secondary partition blanks 40f, 40g thereby cooperate to form an efficient partitioning structure in terms of material utilization.

In some embodiments, a height Hp of each of the primary and secondary partition blanks 40f, 40g is less than the height Hc of the container to be partitioned. Reducing the height Hp of each partition blank 40f, 40g leads to further reductions in the amount of material used to effectively partition a container and is therefore particularly advantageous for environmental impact reasons, as well as for reducing material costs.

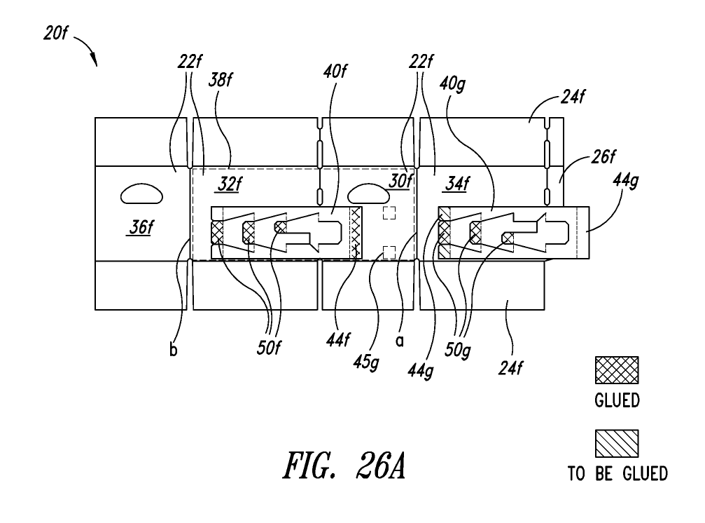

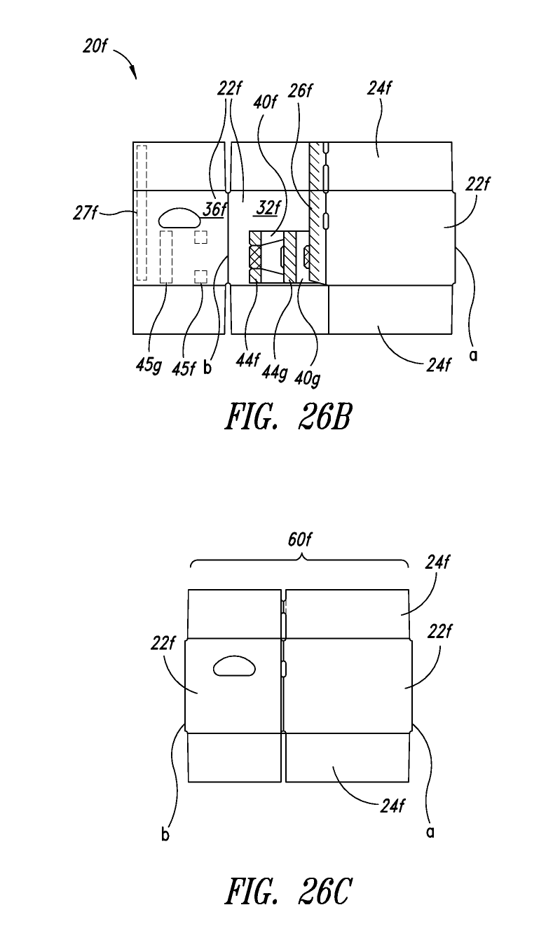

With reference to FIGS. 26A-C, the first or primary partition blank 40f is configured to attach to an outer case blank 20f (the outer case blank 20f comprising a conventional configuration including side panels 22f, top and bottom flaps 24f and a glue flap 26f) preferably within a partition receiving zone 38f—the partition receiving zone 38f being located within the combined area of two adjacent interior side surfaces 30f, 32f of the outer case blank 20f. The first or primary partition blank 40f is attached, preferably via adhesive or glue, in a flat condition to a first side surface 30f of the outer case blank 20f via a divider panel contact region 44f and attached, preferably via adhesive or glue, to a second side surface 32f via a number of the cross member contact regions 50f. According to the illustrated embodiment, the secondary partition blank 40g is similarly attached in a flat condition to a third side surface 34f of the outer case blank 20f via a number of the cross member contact regions 50g of the secondary partition blank 40g; however, the secondary partition blank 40g may alternatively be placed within the partition receiving zone 38f and/or attached to the primary partition blank 40f for subsequent attachment to the third side surface 34f of the outer case blank 20f when the outer case blank 20f is folded, as described below.

With at least the primary partition blank 40f in the partition receiving zone 38f, the outer case blank 20f may be folded about fold line a (FIG. 26B) and fold line b (FIG. 26C) to substantially enclose the primary partition blank 40f and the secondary partition blank 40g therein. When folding the outer case blank 20f in this manner the primary partition blank 40f is attached, preferably via adhesive or glue, to a fourth side surface 36f of the outer case blank 20f and the secondary partition blank 40g is attached to the first side surface 30f and the fourth side surface 36f of the outer case blank 20f. Broken lines 45g in FIG. 26A illustrate where the first side surface 30f contacts divider panel contact regions 44g of the secondary partition blank 40g and broken lines 45f and 45g in FIG. 26B illustrate where the fourth side surface 36f contacts divider panel contact regions 44f, 44g of the primary and secondary partition blanks 40f, 40g, respectively.

End side panels of the outer case blank 20f are secured together, preferably glued, via glue flap 26f as indicated by broken lines 27f in FIG. 26B to complete an erectable container structure 60f that is configured to erect or expand from a flat condition, wherein both of the primary partition blank 40f and the secondary partition blank 40g remain flat, to an expanded condition, wherein the primary and the secondary partition blanks 40f, 40g are erected to form partitioned cells—the primary and the secondary partition blanks 40f, 40g cooperating with each other to create the plurality of cells. In other words, the partition blanks 40f, 40g are automatically and simultaneously erected with the outer case to partition the formed container into a plurality of cells.

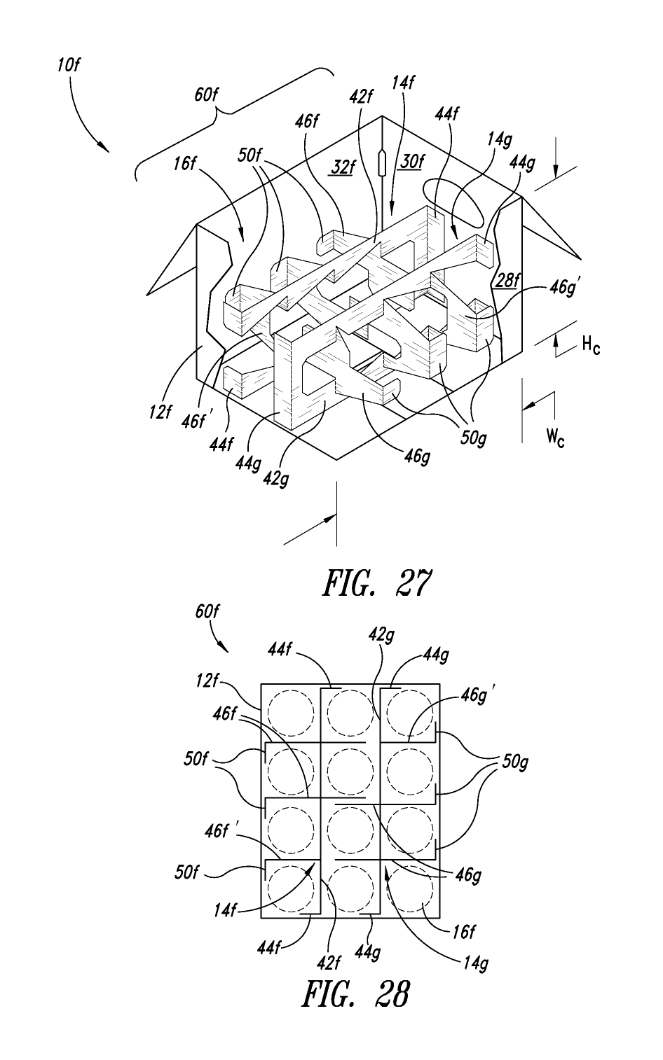

FIGS. 27 and 28 illustrate the erectable container structure 60f in the expanded condition with partitions 14f, 14g shown dividing the outer case 12f into twelve cells 16f. As shown, at least some of the cross members 46f, 46g of the primary and secondary partition 14f, 14g attach to an interior surface of the outer case 12f and extend across a divider panel 42f, 42g and terminate between the divider panel 42f of the primary partition 14f and the divider panel 42g of the secondary partition 14g. In this manner, end portions of some of the cross members 46f, 46g extend partially across the space between the divider panels 42f to form a number of the cells 16f and to prevent contact between adjacent articles in a reduced form that requires relatively less material than would otherwise be required of cross members that extend completely between divider panels. Other cross members 46f′, 46g′ of the primary and secondary partition member 14f, 14g attach to an interior surface of the outer case 12f and extend to and terminate at the divider panels 42f, 42g.

Although the illustrated embodiment includes three cross members 46f, 46f′, 46g, 46g′ on each partition 14f, 14g, more or fewer cross members may be used to partition the container 10f. For example, two cross members on each partition 14f, 14g may be used to partition the container 10f into nine cells. In addition, the cross members 46f, 46f′, 46g, 46g′ may be selectively located throughout the height Hc of the container 10f and may vary in size and shape to separate articles of various profiles and/or protect different areas of such articles.

A method for forming an erectable partitioned container according to one embodiment is described with reference to FIGS. 11 through 12C and begins where a first unitary partition blank 40c having a plurality of cross members 46c and one or more divider panels 42c is formed from raw stock material, such as, for example, paperboard, so that each cross member 46c is rotatably connected to the one or more divider panels 42c for rotation about a divider panel rotation axis 48c from a flat configuration or condition to an erected configuration or condition. The partition blank 40c is preferably formed via a diecutting process wherein profile edges defining the outer contours of the cross members 46c are formed by cutting completely through the sheet of paperboard and wherein perforated, creased and/or scored fold lines are formed at cross member rotation axes 48c for rotating the cross members 46c relative to the divider panel 42c and also at contact region rotation axes 49c for rotating the cross members 46c relative to cross member contact regions 50c. Likewise, additional perforated, creased and/or scored fold lines may be formed at divider panel rotation axes 47c to allow any panel divider contact regions 44c that may form part of the partition blank 40c to rotate relative to the one or more divider panels 42c.

In some embodiments, a second complementary partition blank 40c′ having identical or similar features to the first partition blank 40c may be formed. In other embodiments, the first partition blank 40c is sufficient to effectively partition the interior of a container, and therefore forming a second partition blank 40c′ is not required.

When forming the one or more partition blanks 40c, 40c′, a variety of different size and shaped cross members and divider panels may be formed. In addition, partition blanks may erect or expand to separate a container into a differing number of cells, such as, for example, six, nine or twelve cells, depending on the configuration of the formed blank. The number of cross members and divider panels of the partition blanks may also vary.

For example, the partition blank 40a of FIG. 2 is configured to separate a container into six substantially equal cells using the six cross members 46a shown, however, a partition blank formed to include one divider panel and only two cross members can likewise divide a container into six substantially equal cells. As another example, the partition blank 40b of FIG. 6 is configured to separate a container into twelve substantially equal cells using the 12 cross members 46b shown, however, a partition blank formed to include two divider panels and only six cross members can likewise divide a container into twelve substantially equal cells. As yet another example, the partition blank 40c of FIG. 11 is configured to cooperate with an identical partition blank 40c′ or a similar partition blank 40d (FIG. 15) to separate a container into twelve substantially equal cells using five cross members 46c, 46d on each partition, however, a pair of partition blanks each formed to include one divider panel and only three cross members can likewise divide a container into twelve substantially equal cells. As still yet another example, the foldable partition blank 40e of FIG. 19 is configured to separate a container into six substantially equal cells using the six cross members 46e shown, however, a foldable partition blank formed to include one divider panel and only four cross members can likewise divide a container into six substantially equal cells.

With reference again to FIGS. 11 through 12C, after forming the first partition blank 40c, a contact region 50c rotatably connected to at least one of the plurality of cross members 46c is attached to an interior surface 30c, 32c of an outer case blank 20c, the outer case blank 20c comprising a conventional configuration including side panels 22c, top and bottom flaps 24c and a glue flap 26c. Attachment to the outer case blank 20c is preferably carried out by applying a glue or adhesive, either by hand or by an automated process, to the outer case blank 20c and/or the portion of the partition blank 40c to be attached and then, with the partition blank 40c appropriately located, applying pressure to the combination of the partition blank 40c and outer case blank 20c. In some embodiments where the partition blank 40c includes one or more divider panel contact regions 44c, the one or more divider panel contact regions 44c may be attached in a similar manner to the first and/or a second interior surface 30c, 32c of the outer case blank 20c. In some embodiments that include more than one partition blank 40c, 40c′, the second partition blank 40c′ may be attached to the outer case blank 20c in a similar manner as the first partition blank 40c, or attached to the first partition blank 40c, prior to performing the folding steps discussed below.

Next, the outer case blank 20c is folded about fold line a and about fold line b to enclose the one or more partition blanks 40c, 40c′ within the outer case blank 20c. When folding the outer case blank 20c in this manner, additional cross member contact regions 50c and/or divider panel contact regions 44c may be attached to a third interior surface 34c and/or a fourth interior surface 36c of the outer case blank 20c. For example, as illustrated in FIGS. 12B-C, the divider panel contact region 44c of the second partition blank 40c′ is attached to the fourth interior surface 36c as the outer case blank 20c is folded about line b. Again, attachment is preferably carried out by applying a glue and/or adhesive to the outer case blank 20c and/or the portion of the partition blank 40c, 40c′ to be attached. Also when folding the case blank 20c in this manner, the glue flap 26c of the outer case blank 20c is attached, preferably glued, to an end of the fourth interior surface 36c to complete an erectable partitioned container 60c—the erectable partitioned container 60c being configured, when the outer case is erected, to automatically and simultaneously erect or expand the one or more partitions 40c, 40c′ attached therein. In other words, when the outer case blank 20c is erected in the conventional way, the one or more partition blanks 40c, 40c′ attached therein are automatically erected or expanded to form a partitioned container. This automatic erecting of the partition member(s) conveniently reduces the complexity of and the time required for forming partitioned containers.

Although embodiments of the present invention have been described particularly with reference to partitioned containers having six or twelve cells, one of ordinary skill in the art will appreciate that the present invention is not limited in scope to partitioned containers having only twelve or six cells. For example, other embodiments may comprise an erectable container structure having one or more partition blanks adapted to form nine cells, for example, in three rows and three columns.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of forming an erectable partitioned container, the method comprising:
forming a unitary partition blank to include at least one divider panel to divide an interior of the partitioned container into a plurality of rows and at least one cross member to divide the interior of the partitioned container into a plurality of columns when the unitary partition blank is erected to form a partition structure;
coupling a contact region of the unitary partition blank to an interior surface of an outer case blank with an entirety of the at least one divider panel unfolded and unbonded to any other portion of the partition structure; and
folding the outer case blank to couple an end of the outer case blank to a flap of the outer case blank and form an erectable container structure in a flat configuration, the erectable container structure substantially enclosing the unitary partition blank and being configured to rotate the at least one cross member of the unitary partition blank relative to the at least one divider panel to an erected configuration when the erectable container structure is erected to form the partitioned container.

2. The method according to claim 1 wherein forming the unitary partition blank to include the at least one divider panel and the at least one cross member includes forming the partition blank to include one divider panel and at least two cross members adapted to form six substantially equal container cells when the erectable container structure is erected.

3. The method according to claim 1 wherein forming the unitary partition blank to include the at least one divider panel and the at least one cross member includes forming the partition blank to include two divider panels and at least six cross members adapted to form twelve substantially equal container cells when the erectable container structure is erected.

4. The method according to claim 1 wherein coupling the contact region of the unitary partition blank to the interior surface of the outer case blank includes coupling a contact region rotatably connected to the at least one divider panel to a side panel of the outer case blank.

5. The method according to claim 1 wherein coupling the contact region of the unitary partition blank to the interior surface of the outer case blank includes coupling a contact region rotatably connected to the at least one cross member to a side panel of the outer case blank.

6. The method according to claim 1, further comprising:
forming a complementary partition blank to include at least one complementary divider panel to divide the interior of the erectable partitioned container into a plurality of rows and at least one complementary cross member to divide the interior of the erectable partitioned container into a plurality of columns when the complementary partition blank is erected to form the partition structure with the unitary partition blank; and
coupling a contact region of the complementary partition blank to another interior surface of the outer case blank with the entirety of the at least one complementary divider panel unfolded and unbonded to any other portion of the partition structure and such that the erectable container structure substantially encloses the complementary partition blank and is configured to automatically rotate the at least one complementary cross member of the complementary partition blank relative to the at least one complementary divider panel to a complementary erected configuration when the erectable container structure is erected to form the partitioned container.

7. The method according to claim 6 wherein forming the unitary partition blank to include the at least one divider panel and the at least one cross member includes forming the partition blank to include one divider panel and at least three cross members, and wherein forming the complementary partition blank to include the at least one complementary divider panel and the at least one complementary cross member includes forming the complementary partition blank to include one complementary divider panel and at least three complementary cross members, the unitary partition blank and the complementary partition blank cooperating to form twelve substantially equal cells when the erectable container structure is erected.

8. The method according to claim 6, further comprising:
coupling one or more of the complementary cross members of the complementary partition blank to a corresponding cross member of the unitary partition blank.

9. The method of according to claim 1, further comprising:
applying adhesive to at least a portion of each of opposing sides of the unitary partition blank for coupling the unitary blank to the outer case blank.

10. A method of forming an erectable partitioned container, the method comprising:
forming a first unitary partition blank having one or more cross members rotatably connected to one or more divider panels for rotation to an erected configuration to form a partition structure;
coupling a contact region of the first unitary partition blank to an outer case blank with an entirety of the one or more divider panels unfolded and unbonded to any other portion of the partition structure; and
folding the outer case blank to form an erectable container structure in a flat configuration, the erectable container structure enclosing the first unitary partition blank and being configured to automatically rotate the one or more cross members relative to the one or more divider panels to the erected configuration when the erectable container structure is erected to form a partitioned container having at least four container cells.

11. The method according to claim 10, further comprising:
forming a second unitary partition blank having one or more cross members rotatably connected to one or more divider panels for rotation to an erected configuration, the first unitary partition blank and second unitary partition blank configured to cooperate to divide an interior of the partitioned container into the at least four container cells when the erectable container structure is erected.

12. The method according to claim 11, further comprising:
coupling a portion of at least one cross member of the first unitary partition blank to a corresponding portion of at least one cross member of the second unitary partition blank.

13. The method according to claim 10 wherein the first unitary partition blank includes two divider panels integrally connected by an intermediate span and a plurality of cross members integral to each of the divider panels, and wherein coupling the contact region of the first unitary partition blank to the outer case blank includes coupling the intermediate span to an interior surface of the outer case blank.

14. The method according to claim 10 wherein coupling the contact region of the first unitary partition blank to the outer case blank includes coupling the contact region of the first unitary partition blank to the outer case blank with the first unitary blank in an entirely flat, unfolded configuration.

15. The method according to claim 10 wherein the first unitary partition blank includes two divider panels integrally connected by an intermediate span, and further comprising:
folding the first unitary partition blank such that one of the divider panels abuts at least a portion of the other one of the divider panels prior to folding the outer case blank.

16. The method of according to claim 10, further comprising:
applying adhesive to at least a portion of each of opposing sides of the first unitary partition blank for coupling the first unitary partition blank to the outer case blank.
